(19) United States
(12) Patent Application Publication
(10) Pub. No.: US 2022/0194308 A1
(43) Pub. Date: Jun. 23, 2022

(54) ELECTRONIC SYSTEM WITH A DECREASED STATIC POWER CONSUMPTION

(71) Applicant: STMicroelectronics (Rousset) SAS, Rousset (FR)

(72) Inventor: Philippe BIENVENU, Saint-Maximin (FR)

(73) Assignee: STMicroelectronics (Rousset) SAS, Rousset (FR)

(21) Appl. No.: 17/550,256

(22) Filed: Dec. 14, 2021

(30) Foreign Application Priority Data
Dec. 18, 2020 (FR) 2013744

(51) Int. Cl. B60R 16/033; G05F 1/46

(52) U.S. Cl. CPC B60R 16/033; G05F 1/46

(57) ABSTRACT

An electronic system includes at least one first electronic circuit and a voltage regulator connected electrically in parallel between first and second nodes, where the voltage regulator is configured to generate a regulated voltage at the second node. At least one second electronic circuit is connected between the second node and a third node providing a reference for the regulated voltage.

### PRIORITY CLAIM

This application claims the priority benefit of French Application for Patent No. 2013744, filed on Dec. 18, 2020, the content of which is hereby incorporated by reference in its entirety to the maximum extent allowable by law.

### TECHNICAL FIELD

The present disclosure generally concerns an electronic system comprising electronic circuits.

### BACKGROUND

The static power consumption of an electronic system is the electric power consumed by the electronic system independently of its activity. By way of example, for an electronic system corresponding to an integrated circuit comprising metal oxide semiconductor field effect transistors, the static consumption includes the consumption to maintain the logical states of the transistors. It is generally desirable for the static power consumption of an electronic system to be as low as possible.

For certain applications, the static power consumption of the electronic system may be a critical factor. This is true in the automobile field, the electronic system then corresponding to the automobile's on-board network. Indeed, when the electronic system is powered with a battery, the static power consumption of the electronic system has a direct impact on the autonomy of the battery. Further, a high electrical consumption also causes a rise in temperature of the electronic modules which is detrimental. Further, the tendency is towards the increase of the power supply voltage of the on-board networks of automobiles, which causes an increase in the static power consumption.

There is a need in the art to provide an electronic system overcoming all or part of the disadvantages of the previously-described electronic systems.

There is also a need in the art for the electronic system to have a decreased static power consumption.

### SUMMARY

One embodiment provides an electronic system comprising, electrically in parallel between first and second nodes, at least one first electronic circuit powered between the first and second nodes, a regulator of a voltage between the first node and the second node, and a second electronic circuit between the second node and a third node.

One embodiment provides also a method comprising the power supply between first and second nodes of at least a first electronic circuit, the regulation of a voltage between the second node and a third node by a regulator electrically in parallel with the first electronic circuit between the first and second nodes, and the power supply between the second and third nodes of a second electronic circuit.

According to an embodiment, the electronic system or method comprises a first switch in series with the first electronic circuit between the first and second nodes.

According to an embodiment, the electronic system or method comprises a second switch coupling the third node to a connection node in series between the first electronic circuit and the first switch.

According to an embodiment, at least one third electronic circuit is powered between the first and third nodes.

According to an embodiment, at least one third switch is electrically in series with the third electronic circuit between the first and third nodes.

According to an embodiment, the first electronic circuit comprises a voltage divider.

According to an embodiment, the first electronic circuit comprises an amplifier.

According to an embodiment, the electronic system receives between the first and third nodes a voltage greater than 15 V and the regulator is configured to deliver the voltage between the second and third nodes smaller than 10 V.

One embodiment provides also a vehicle comprising an electronic system as previously defined and a voltage source powering the electronic system.

According to an embodiment, the voltage source comprises a battery of electric cells.

### BRIEF DESCRIPTION OF THE DRAIWNGS

The foregoing features and advantages, as well as others, will be described in detail in the following description of specific embodiments given by way of illustration and not limitation with reference to the accompanying drawings, in which:

FIG. 1 partially and schematically shows an example of an electronic system powered by a battery of cells;

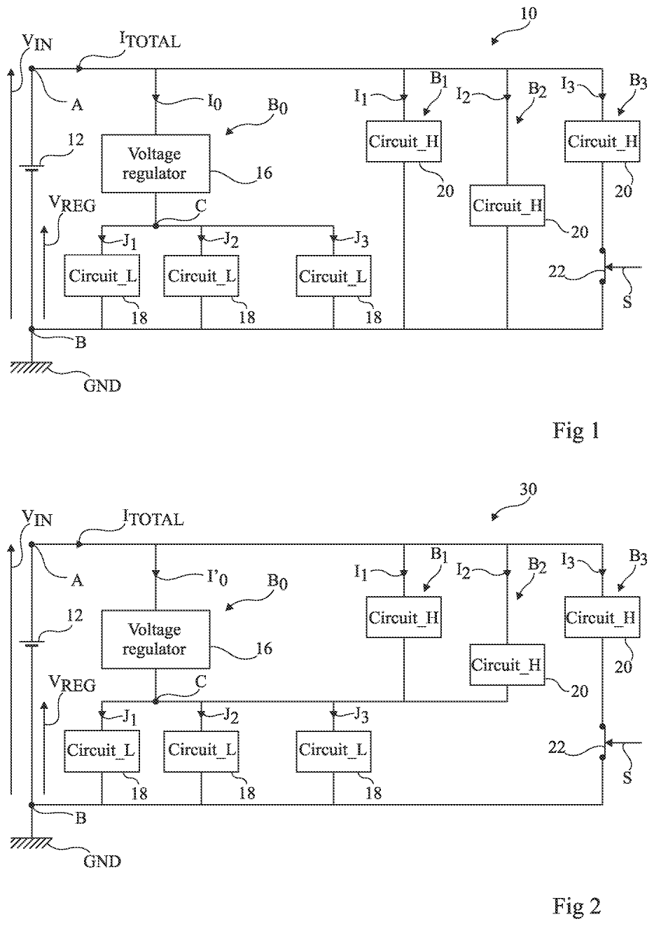

FIG. 2 partially and schematically shows an embodiment of an electronic system powered by a battery of cells;

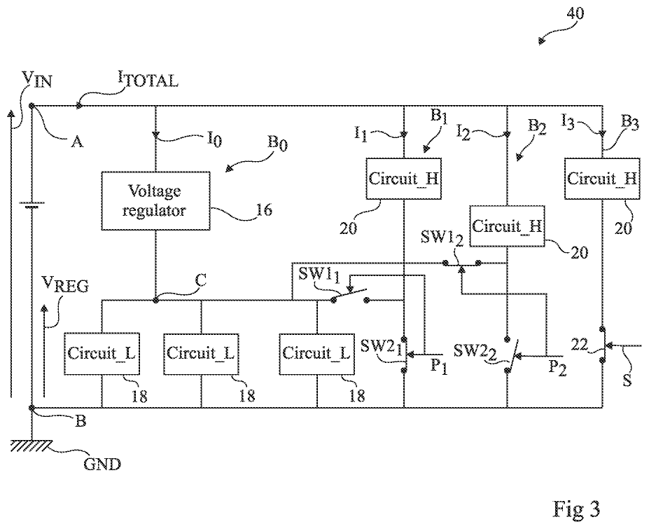

FIG. 3 partially and schematically shows another embodiment of an electronic system powered by a battery of cells;

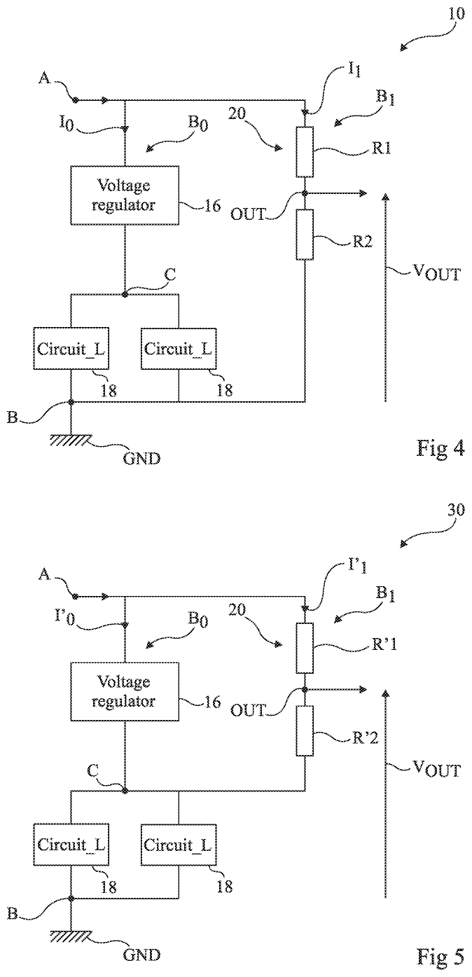

FIG. 4 partially and schematically shows a more detailed example of a portion of the electronic system of FIG. 1;

FIG. 5 partially and schematically shows a more detailed embodiment of a portion of the electronic system of FIG. 2;

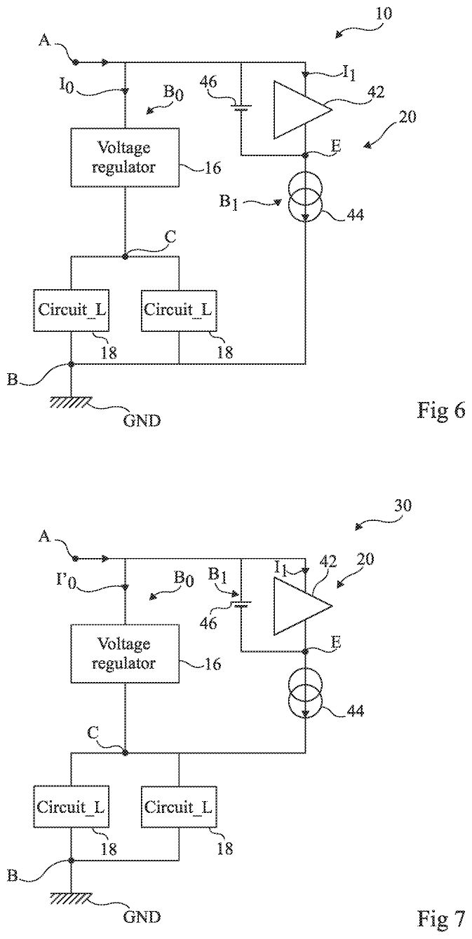

FIG. 6 partially and schematically shows another more detailed example of a portion of the electronic system of FIG. 1; and

FIG. 7 partially and schematically shows another more detailed embodiment of a portion of the electronic system of FIG. 2.

### DETAILED DESCRIPTION

Like features have been designated by like references in the various figures. In particular, the structural and/or functional features that are common among the various embodiments may have the same references and may dispose identical structural, dimensional and material properties. For the sake of clarity, only the steps and elements that are useful for an understanding of the embodiments described herein have been illustrated and described in detail. Unless indicated otherwise, when reference is made to two elements connected together, this signifies a direct connection without any intermediate elements other than conductors, and when reference is made to two elements coupled together, this signifies that these two elements can be connected or they can be coupled via one or more other elements. Unless specified otherwise, the expressions “around”, “approximately”, “substantially” and “in the order of” signify within 10%, and preferably within 5%.

FIG. 1 shows an example of an electronic system 10 powered by a source 12 of a power supply voltage V_{IN}, for example a battery of electric cells or an electric generator. Electronic system 10 comprises nodes A and B between which the power supply voltage is applied. Node B plays, for electronic system 10, the role of a source of a low reference potential GND.

Electronic system 10 comprises a first circuit branch B₀ connected between nodes A and B. First circuit branch B₀ comprises a voltage regulator 16 powering M electronic circuits 18 (Circuit L), M being an integer greater than or equal to 1, three electronic circuits 18 (M=3) being shown in FIG. 1 as an example.

Voltage regulator 16 comprises an input coupled to node A and an output node C and is configured to deliver a voltage V_{REG} regulated between nodes C and B. The M electronic circuits 18 are assembled in parallel between output node C of voltage regulator 16 and node B. According to an embodiment, voltage regulator 16 is a linear regulator, for example, a shunt-type regulator or a series regulator. Voltage V_{REG} may be lower than voltage V_{IN} and electronic circuits 18 may be circuits capable of being powered at a voltage lower than voltage V_{IN}.

Electronic system 10 comprises a second circuit branch B₁ or plural second circuit branches B₁ to B_{N}, N being a natural integer greater than or equal to 2, connected between nodes A and B, three second circuit branches B₁, B₂, and B₃ (N=3) being shown in FIG. 1 as an example. Each second circuit branch Bⱼ, with j varying from 1 to N, comprises an electronic circuit 20 (Circuit_H).

According to an example of application, electronic system 10 may correspond to a portion of an on-board network of a motor vehicle. The electronic circuits 18 are analog circuits or digital circuits supplied by the voltage regulator 16. Electronic circuits 20 may comprise circuits delivering voltages powering other circuits, not shown, of electronic system 10.

Let I_{TOTAL} be the current delivered at node A and let Iⱼ, with j varying from 0 to N, be the currents flowing in each circuit branch Bⱼ from node A. In particular, current I₀ is the current flowing through voltage regulator 16. By application of the node equation, current I₀ is equal to the sum of currents Iⱼ, with j varying from 0 to N. When system 10 is inactive, while receiving voltage V_{IN}, it is possible for the currents I₀ to I_{N} to not be equal to zero. At least some of the currents I₀ to I_{N} may then correspond to leakage currents. The static power consumption of electronic system 10 then corresponds to the electric power consumed by the electric system, that is, to the product of voltage V_{IN} and of current I_{TOTAL}. Note: currents J₁ to J_{M} refer to the currents flowing in the M electronic circuits 18. By application of the node equation, for electronic system 10, the sum of currents J₁ to J_{M} is equal to current I₀.

To decrease the static power consumption of electronic system 10, a common practice is to decrease the static power consumption of each circuit 18 and 20. Another common practice is to interrupt the power supply of certain circuits 18 and 20 when it is possible with respect to the activity of electronic system 10. For this purpose, as an example, at least one of circuit branches Bⱼ, with j varying from 1 to N, may comprise a switch 22 in series with an electronic circuit 20, a switch 22 being shown on circuit branch B₃ in FIG. 1 as an example. Switch 22 may be controlled by a signal S, for example delivered by one of electronic circuits 18. The turning off of switch 22 causes the stopping of the flowing of current Iⱼ through circuit branch Bⱼ, with j varying from 1 to N.

However, for certain applications, the decrease in the static power consumption of electronic system 10, obtained by decreasing the static power consumption of each circuit 18 and 20 and/or by interrupting the power supply of certain circuits 18 and 20 may be insufficient.

FIG. 2 partially and schematically shows an embodiment of an electronic system 30. Electronic system 30 comprises all the elements of electronic system 10, with the difference that at least one of the circuit branches Bⱼ, with j varying from 1 to N, is not connected between nodes A and B but between nodes A and C. As an example, in FIG. 2, circuit branches B₁ and B₂ are shown as being connected between nodes A and C.

Let I′₀ be the current flowing through voltage regulator 16 for electronic system 30 in FIG. 2 to highlight the fact that the intensity of this current is different from that of the current I₀ flowing through voltage regulator 16 for electronic system 10 in FIG. 1. The other currents Iⱼ, with j varying from 1 to N, flowing through circuit branches Bⱼ for electronic system 30 in FIG. 2 being substantially the same as for electronic system 10. By application of the node equation, for electronic system 30, the sum of currents J₁ to J_{M} is equal to the sum of current I′₀ and of the currents Iⱼ of the circuit branches Bⱼ connected to node C. As a result, for electronic system 30, current I_{TOTAL} is equal to the sum of current I′₀ and of the currents of the circuit branches Bⱼ which are not connected to node C.

The intensity of current I_{TOTAL} for electronic system 30 is thus smaller than the intensity of current I_{TOTAL} for electronic system 10. A decrease in the static power consumption of electronic system 30 with respect to electronic system 10 is thus obtained.

It may be desirable for all circuit branches Bⱼ, with j varying from 1 to N, to not be connected between nodes A and C, but for some of circuit branches Bⱼ, with j varying from 1 to N, to remain connected between nodes A and B. This may occur inasmuch as it may be desirable for current I′₀ to remain positive for the operation of voltage regulator 16. This may further occur when the electronic circuit 20 of a circuit branch Bⱼ needs, for its operation, a voltage reference with little noise. Indeed, the potential of node B is less noisy than the potential at node C. This can also be the case when the electronic circuit 20 of a circuit branch Bⱼ has a noisy consumption current Iⱼ capable of disturbing the regulation voltage at node C.

According to an embodiment, power supply voltage V_{IN} is greater than 10 V. According to an embodiment, a converter, not shown, may be provided between battery 12 and node A. According to an embodiment, voltage regulator 16 is configured to deliver regulated voltage V_{REG} in the range from 2 V to 6 V, for example, approximately equal to 3 V or approximately equal to 5 V.

As an example, electronic circuit 20 may be a circuit delivering a voltage for the biasing of an electronic component of the electronic system, not shown, for example, an insulated-gate field-effect transistor, also called MOS transistor.

Advantageously, the decrease in the static power consumption of system 30 is obtained without causing a decrease in the intensity of the currents Iⱼ flowing through circuit branches Bⱼ, with j varying from 1 to N. This enables to keep currents Iⱼ of sufficiently high intensities for the proper operation of electronic circuits 20.

FIG. 3 partially and schematically shows another embodiment of an electronic system 40. Electronic system 40 comprises all the elements of the electronic system 30 shown in FIG. 2 and further comprises, for each of the circuit branches Bⱼ, with j varying from 1 to N, which are coupled to node C, a first switch SW1ⱼ coupling the circuit 20 of circuit branch Bⱼ to node C and a second switch SW2ⱼ coupling the circuit 20 of circuit branch Bⱼ to node B. Switches SW1ⱼ and SW2ⱼ are complementarily controlled by a signal Pⱼ. This means that when one of switches SW1ⱼ and SW2ⱼ is off, the other one of switches SW1ⱼ and SW2ⱼ is on. Signals Pⱼ may be delivered by one of circuits 18. It is thus possible to connect the circuit branches Bⱼ provided with switches SW1ⱼ and SW2ⱼ between nodes A and B or between nodes A and C. As an example, in FIG. 3, one has shown, for circuit branch B₁, a switch SW1₁ between the circuit 20 of circuit branch B₁ and node C and a switch SW2₁ between the circuit 20 of circuit branch B₁ and node B and, for circuit branch B₂, a switch SW1₂ between the circuit 20 of circuit branch B₂ and node C and a switch SW2₂ between the circuit 20 of circuit branch B₂ and node B.

FIG. 4 partially and schematically shows a more detailed example of a portion of the electronic system of FIG. 1 in the case where the electronic circuit 20 of circuit branch B₁ corresponds to a voltage divider. The electronic circuit 20 of circuit branch B₁ comprises a first resistor R1 between node A and a node OUT and a second resistor R2 between node OUT and node B. The voltage V_{OUT} between node OUT and node B may be used to power another element of electronic system 10, not shown.

FIG. 5 partially and schematically shows a more detailed example of a portion of the electronic system 30 of FIG. 2 in the case where electronic circuit 20 of circuit branch B₁ also corresponds to a voltage divider. Electronic circuit 20 comprises a first resistor R′1 between node A and node OUT and a second resistor R′2 between node OUT and node C. The voltage V_{OUT} between node OUT and node B may be used to power another element of electronic system 30, not shown. The resistances of resistors R′1 and R′2 are to be adjusted so that the voltage V_{OUT} of electronic system 30 is identical to the voltage V_{OUT} of electronic system 10.

FIG. 6 partially and schematically shows a more detailed example of a portion of the electronic system 10 of FIG. 1 in the case where the electronic circuit 20 of circuit branch B₁ corresponds to an amplification circuit. The electronic circuit 20 of circuit branch B₁ comprises an amplifier 42 having a power supply node connected to node A and having its other power supply node connected to a node E. The electronic circuit 20 of circuit branch B₁ further comprises a current source 44, delivering current I₁, between node E and node B. A source 46 of a constant voltage, for example, a Zener diode, is provided between nodes A and E. The input of amplifier 42 and the output of amplifier 42 are connected to other electronic circuits of electronic system 10, not shown.

FIG. 7 partially and schematically shows a more detailed example of a portion of the electronic system 30 of FIG. 2 in the case where the electronic circuit 20 of circuit branch B₁ also corresponds to an amplification circuit. The amplification circuit of FIG. 2 has the same structure as that shown in FIG. 6, with the difference that current source 44 is assembled between node E and node C.

Various embodiments and variants have been described. Those skilled in the art will understand that certain features of these various embodiments and variants may be combined, and other variants will occur to those skilled in the art. Finally, the practical implementation of the described embodiments and variations is within the abilities of those skilled in the art based on the functional indications given hereabove.

1. An electronic system, comprising:
a first node;
a second node;
a third node;
at least one first electronic circuit powered between the first and second nodes;
a voltage regulator circuit connected between the first node and the second node and configured to supply a regulated voltage at the second node;
wherein the at least one first electronic circuit and the voltage regulator circuit are electrically in parallel between the first and second nodes; and
at least one second electronic circuit powered between the second node and the third node.

2. The electronic system according to claim 1, further comprising a first switch in series with the at least one first electronic circuit between the first and second nodes.

3. The electronic system according to claim 2, further comprising a second switch coupling the third node to a connection node in series between the at least one first electronic circuit and the first switch.

4. The electronic system according to claim 1, further comprising at least one third electronic circuit powered between the first and third nodes.

5. The electronic system according to claim 4, further comprising at least one third switch in series with the at least one third electronic circuit between the first and third nodes.

6. The electronic system according to claim 1, wherein the at least one first electronic circuit comprises a voltage divider.

7. The electronic system according to claim 1, wherein the at least one first electronic circuit comprises an amplifier.

8. The electronic system according to claim 1, further comprising voltage source connected between the first and third nodes and configured to provide a voltage greater than 15 V and wherein the voltage regulator is configured to deliver a voltage between the second and third nodes smaller than 10 V.

9. A vehicle, comprising an electronic system according to claim 1 and a voltage source connected between the first and third nodes.

10. The vehicle according to claim 10, wherein the voltage source comprises a battery.

11. An electronic system, comprising:
a first node;
a second node;
a third node;
wherein the first node is configured to receive a supply voltage referenced to the third node;
at least one first electronic circuit having a first terminal connected to the first node and having a second terminal connected to the second node;
a voltage regulator circuit receiving power from the first node and configured to generate at the second node a regulated voltage referenced to the third node; and
at least one second electronic circuit having a first terminal connected to the second node and having a second terminal connected to the third node.

12. The electronic system according to claim 11, further comprising a first switch in series with the at least one first electronic circuit between the first and second nodes.

13. The electronic system according to claim 12, further comprising a second switch coupling the third node to a connection node in series between the at least one first electronic circuit and the first switch.

14. The electronic system according to claim 13, wherein the first switch is controlled to be closed when the second switch is controlled to be open, and vice versa.

15. The electronic system according to claim 11, further comprising at least one third electronic circuit having a first terminal connected to the first node and having a second terminal connected to the third node.

16. The electronic system according to claim 15, further comprising at least one third switch in series with the at least one third electronic circuit between the first and third nodes.

17. A vehicle, comprising an electronic system according to claim 11 and a voltage source configured to provide said supply voltage.

18. The vehicle according to claim 17, wherein the voltage source comprises a battery.

19. An electronic system, comprising:
a first node;
a second node;
a third node;
a battery voltage connected between the first and third nodes;
a voltage regulator circuit receiving the battery voltage from the first node and configured to generate a regulated voltage less than the battery voltage between the second and third nodes;
a first electronic circuit connected between the first and third nodes;
a second electronic circuit connected between the first and third nodes in parallel with the voltage regulator circuit; and
a third electronic circuit connected between the first and third nodes.

20. The electronic system according to claim 1, further comprising:
a first switch connected in series with the first electronic circuit between the first and third nodes, said first switch controlled by a first control signal;
a second switch connected in series with the second electronic circuit between the first and third nodes, said second switch controlled by a second control signal; and
a third switch connected in series with the second electronic circuit between the first and second nodes, said third switch controlled by a third control signal;
wherein the second switch is controlled to be closed in response to the second control signal when the third switch is controlled to be open in response to the third control signal, and vice versa.
